(19) United States
(12) Patent Application Publication
(10) Pub. No.: US 2008/0003950 A1
(43) Pub. Date: Jan. 3, 2008

(54) Controlling switching mode power supply of power amplifier

(75) Inventors: Sami Haapoja, Helsinki (FI); Vlad Grigore, Vantaa (FI); Seppo Kangasmaa, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/517,269

(22) Filed: Sep. 8, 2006

(30) Foreign Application Priority Data
Jun. 30, 2006 (FI) 20065457

(51) Int. Cl. H04B 1/38

(52) U.S. Cl. 455/73

(57) ABSTRACT

A radio frequency transceiver is provided. The transceiver comprises a receiver for receiving transmission at a first radio frequency and a transmitter for transmitting at a second radio frequency, and in the transmitter a power amplifier with a switching mode power supply. The transceiver further comprises a controller configured to vary switching frequency of the switching mode power supply on the basis of a frequency separation of the first and the second radio frequencies.

### FIELD

The invention relates to switching mode power supplies generally used in radio frequency transmitters. More specifically, the invention relates to controlling the switching mode power supplies.

### BACKGROUND

Switching mode power supplies (SMPS) are used to feed power to a power amplifier. This kind of structure is used in many portable radio transmitters between the battery and power amplifier of the transmitter, for example. The main reason for using a switching mode power supply is its good efficiency. For example, a linear regulator has a much greater power loss compared to a switching mode power supply.

FIG. 1 illustrates an example of an efficient RF transmitter topology. The transmitter comprises a radio frequency power amplifier 100 which amplifies a signal 102 to be transmitted before transmission using an antenna 104. The transmitter further comprises a battery 106 which provides a battery voltage V_{BAT}. The battery voltage is taken to a switching mode power supply 108 which acts as a DC-DC converter and converts the battery voltage to the power amplifier supply voltage V_{PA}. As an input, the switching mode power supply may have a reference voltage V_{M} which may be used to control the power supply. Typically, the power amplifier is a non-linear power amplifier but it may also be a linear amplifier.

Typically, a switching mode power supply comprises a switching converter (power stage) and a control circuit. There are many ways to implement an SMPS, depending on the type of the switching converter and on the type of its control. The switching converter comprises a switching arrangement which connects the battery voltage to the load (power amplifier) via a filtering arrangement. Typically, the filtering arrangement is an LC filter, but other realizations exist. The switching arrangement is switched on/off with a given switching frequency F_{S}. Typically, an LC filter has a quite low corner frequency compared to that of the switching frequency. Therefore, it quite effectively attenuates the components of the switching frequency and harmonics. However, the attenuation is not perfect and therefore the output voltage of the SMPS inherently contains a switching ripple. The ripple consists of a main component at the switching frequency and higher order harmonics that typically have much lower amplitude compared to that of the main component.

The ripple increases the transmitter interference level in the antenna of the transmitter. Especially the first harmonics of the switching frequency are troublesome in transceivers of systems that require simultaneous transmission and reception, such as WCDMA and CDMA2k based systems. In systems like these, the ripple may desentisize the reception. Typical switching frequencies are in the range of 1 to 2 MHz, but in some cases it may be increased e.g. to 10 MHz, in order to achieve a required bandwidth. A high switching frequency degrades the SMPS efficiency.

In radio communication systems utilizing simultaneous transmission and reception, a frequency difference of transmission and reception is called a duplex separation. In most of the existing systems, the duplex separation is constant. However, when new systems are developed the future trend is towards a variable duplex separation. In such systems, if the transmission frequency used is at the highest possible frequency and the reception frequency is at the lowest possible frequency, the duplex separation would be considerably narrower compared to existing systems. This could mean that even the 2nd or 3rd harmonic of the SMPS switching ripple would fall on top of its own reception signal. Furthermore, it is possible that in the future band extensions will be put to use, which may mean even a narrower duplex separation.

Thus, as the transmission and reception frequencies are getting closer to each other, tougher transmission interference specifications are required, especially in full-duplex systems. Furthermore, terminals supporting more than one system present a similar problem. Many receivers of different systems will be active in the same terminal while a transmitter of another system is transmitting in a nearby frequency band. The reception of these different systems may be disturbed by the harmonics of SMPS ripple. To eliminate the SMPS ripple harmonic problem, a straightforward solution would be to use a switching frequency F_{S} which is much higher than 10 MHz and select the F_{S} used such that the harmonic does not fall on top of a simultaneously active receiver. However, this would mean a lower SMPS efficiency and thus higher power consumption. In portable devices this would be a poor solution.

### BRIEF DESCRIPTION OF THE INVENTION

An object of the invention is to provide an improved solution for controlling a switching mode power supply. According to an aspect of the invention, there is provided a radio frequency transceiver comprising a receiver for receiving transmission at a first radio frequency and a transmitter for transmitting at a second radio frequency, and in the transmitter a power amplifier with a switching mode power supply. The transceiver further comprises a controller configured to vary switching frequency of the switching mode power supply on the basis of a frequency separation of the first and the second radio frequencies.

According to another aspect of the invention, there is provided a method for controlling a switching mode power supply of a power amplifier of a transmitter in a radio frequency transceiver comprising a receiver for receiving transmission at a first radio frequency and a transmitter for transmitting at a second radio frequency. In the method, switching frequency of the switching mode power supply is varied on the basis of a frequency separation of the first and the second radio frequencies.

According to another aspect of the invention, there is provided a radio frequency transceiver comprising receiving means for receiving transmission at a first radio frequency and transmitting means for transmitting at a second radio frequency, and in the transmitting means power amplifying means with a switching mode power supply. The transceiver further comprises controlling means for varying switching frequency of the switching mode power supply on the basis of a frequency separation of the first and the second radio frequencies.

According to another aspect of the invention, there is provided a radio frequency transmitter of a transceiver comprising a receiver for receiving transmission at a first radio frequency, the transmitter being configured to transmit at a second radio frequency and comprising a power amplifier with a switching mode power supply. The transceiver further comprises a controller configured to vary switching frequency of the switching mode power supply on the basis of a frequency separation of the first and the second radio frequencies.

According to yet another aspect of the invention, there is provided a switching mode power supply in a radio frequency transmitter of a transceiver comprising a receiver for receiving transmission at a first radio frequency, the transmitter being configured to transmit at a second radio frequency. The switching frequency of the switching mode power supply is adjustable on the basis of a frequency separation of the first and the second radio frequencies.

Embodiments of the invention provide several advantages. The proposed solution is straightforward to implement. It allows a flexible control over the switching mode power supply. As the variation in duplex separation may be taken into account in the control of the SMPS, the radio frequency power amplifier power consumption may be kept efficient over a large variation in the duplex separation. The switching frequencies leading to inefficient power consumption are only needed in case of a very narrow duplex separation, and when a receiver of some other system resides close to the transmission frequency used in the frequency band.

### LIST OF DRAWINGS

In the following, the invention will be described in greater detail with reference to the embodiments and the accompanying drawings, in which

FIG. 1 illustrates an example of an efficient RF transmitter topology;

FIGS. 2A and 2B illustrate examples of a switching mode power supply;

FIG. 2C illustrates different signals in a power supply,

FIG. 3 illustrates an output voltage VPA as a function of a reference voltage V_{M},

FIG. 4 illustrates an example of a radio frequency transceiver to which embodiments of the invention may be applied,

FIG. 5 is a flowchart illustrating an embodiment of the invention, and

FIGS. 6A and 6B illustrate power switch splitting.

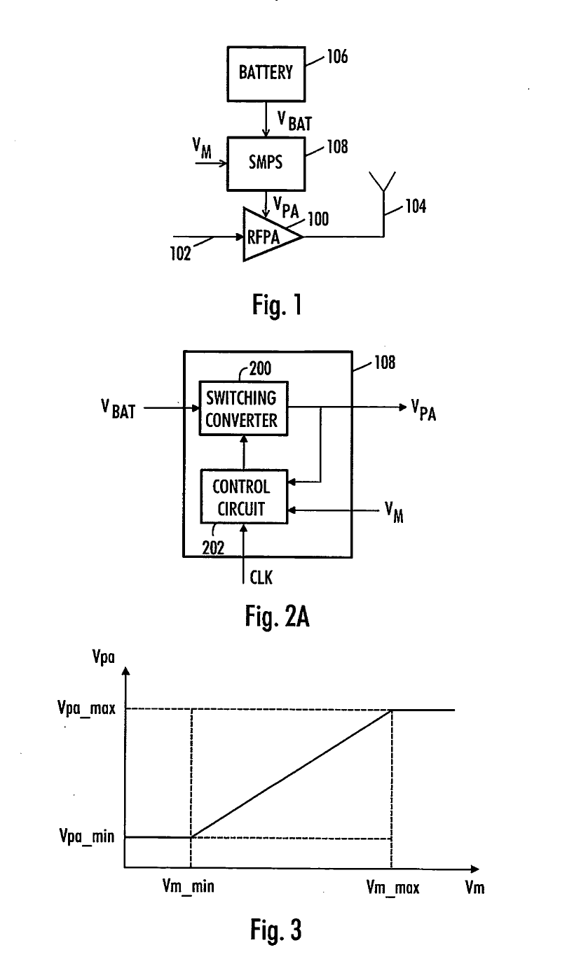

### DESCRIPTION OF EMBODIMENTS

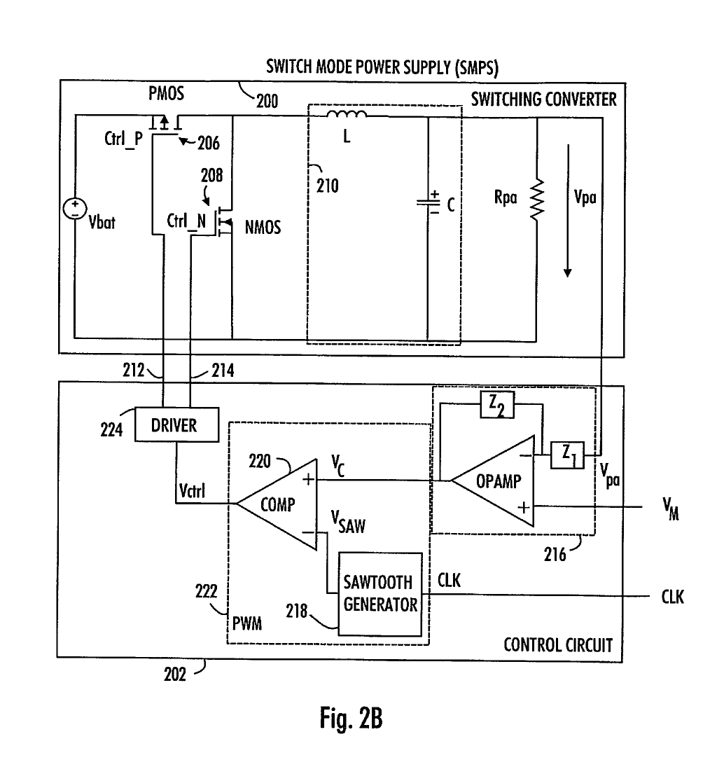

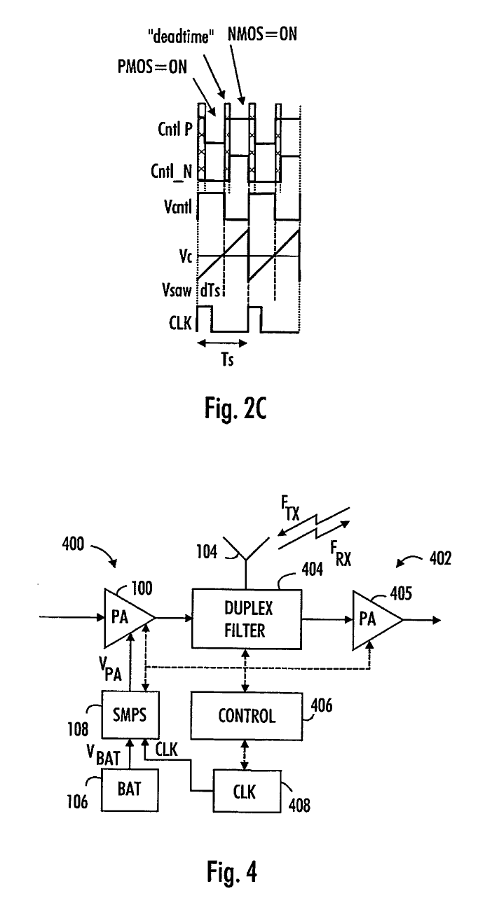

FIG. 2A illustrates an example of a switching mode power supply. The switching mode power supply 108 converts a battery voltage V_{BAT} to a voltage level V_{PA} as required by a power amplifier. A switching mode power supply 108 typically comprises a switching converter 200 or a power stage, and a control circuit 202 of the switching converter. In the example of FIG. 2A, the inputs to the switching mode power supply comprise a reference voltage V_{M} and a clock signal CLK. There are many ways to implement a switching mode power supply, depending on the type of the switching converter and on the type of its control.

The switching converter may be realized as a Buck-type converter which has a step-down characteristic behavior. Thus, an output voltage V_{OUT} of the converter is always lower than the input voltage V_{BAT} of the converter. The converter may be realized as a Boost-type converter having a step-up characteristic behavior, where the output voltage V_{OUT} of the converter is always higher than the input voltage V_{BAT}. A Buck-Boost converter has a step-up/down characteristic behavior. In such a case, the output voltage V_{OUT} may be lower or higher than the input voltage V_{BAT}. In addition, several other topologies with various characteristics exist.

There are several possible control methods. In a voltage-mode control, the output voltage of the converter is measured and used as feedback to close the control loop. In a current-mode control, both the output voltage and a current in the circuit are measured and used as feedback. In addition, several other control methods with various characteristics exist, as is known to one skilled in the art.

FIG. 2B illustrates an example of a typical switching mode power supply comprising a switching converter 200 and a control circuit 202. FIG. 2C illustrates different signals in the power supply. In this example, the switching converter 200 is a Buck-type converter, and the control circuit 202 implements voltage-mode control. It should be noticed that FIG. 2B is merely an example of the many SMPS types to which the embodiments may be applied. The embodiments are not limited to Buck-type converters and voltage-mode control.

The switching converter 200 comprises two semiconductor devices 206, 208 used as switches, and an LC filter 210. In this example, the semiconductor switches are realized with two complimentary MOS transistors, a PMOS transistor 206 and an NMOS transistor 208. It is also possible to use semiconductor switches of other types. The switches are switched ON-OFF alternatively, with a switching frequency F_{S}=1/T_{S}, thus applying a Pulse-Width-Modulated (PWM) voltage to the LC filter 210. The filter 210 essentially extracts a DC component (V_{PA}) of the PWM voltage and applies it to the load. In such a case, the load is an RF Power Amplifier and is represented here as a resistive load R_{PA}. A saturated power amplifier can be approximated as a constant resistive load from the point of view of SMPS. Typically, the LC filter 210 has quite a low corner frequency compared to the switching frequency, and therefore it attenuates quite effectively the components at the switching frequency F_{S} and its harmonics. However, the attenuation is not perfect and therefore the output voltage of the SMPS V_{PA} contains a switching ripple. The ripple consists of a main component at the switching frequency and higher order harmonics that typically have much lower amplitude compared to that of the main component.

The output voltage V_{PA} of the converter is controlled via a “duty-cycle” of a Pulse Width Modulator (PWM) of the control circuit. The duty cycle represents the ratio of conduction time of the PMOS, tₒₙ_{_{—}}_{PMOS}, to a switching period Ts: V_{PA}=d*V_{BAT} (duty-cycle d may take values in the range 0 . . . 1, therefore, it can be seen that in this type of converter the output voltage is always lower than the input voltage).

The role of the control circuit 202 is to ensure that the output voltage V_{PA} is regulated to be at a given reference value V_{M}. In practice, as input signals the control circuit has the measured output voltage V_{PA}, the reference voltage V_{M}, and an external clock signal CLK and, as output signals, control signals 212, 214 for the converter switches, with the right duty-cycle d. The external clock signal CLK is a signal coming from a clock circuit in a radio frequency integrated circuit RFIC of the transmitter. It determines the switching frequency F_{S}.

The control circuit comprises a compensator 216 which comprises an operational amplifier OPAMP with impedances Z1 and Z2. In practice, these impedances are formed with resistors and capacitors and they shape the frequency response of the compensator in order to ensure the desired crossover frequency and phase margin in a control loop. The compensator 216 defines the dynamic behavior of the SMPS (transient response, for example). The output of the compensator is a signal V_{C}.

The control circuit further comprises a sawtooth generator 218. The generator generates a sawtooth signal V_{SAW} synchronized with the external clock signal CLK.

The control circuit further comprises a comparator 220 which generates a control signal V_{CTRL} by comparing the sawtooth V_{SAW} with V_{C}. The resulting control signal V_{CTRL} is pulse-width-modulated with a duty-cycle d as necessary to regulate V_{PA} to be close to the reference V_{M}: e.g. if V_{PA} decreases ->V_{C} increases ->d increases ->V_{PA} increases. The sawtooth generator 218 and the comparator 220 form a so-called Pulse-Width-Modulator 222 (having V_{C} as input and PWM signal V_{CTRL} as output).

Finally, the control circuit further comprises a driver 224. As input, the driver 224 has the PWM signal V_{CTRL} and, as outputs, the control signals 212, 214 for the two switches. Typically, these control signals have three basic purposes. First, they must have the right sequence for the combination of switches that is used (PMOS+NMOS or NMOS+NMOS). Second, they must provide the right voltage levels and to have the right current capability in order to drive the switches ON/OFF fast enough. Finally, they provide “dead time” which is introduced at transitions between one switching interval to the next one. During this “dead time”, both switches are OFF for a very short time interval in order to avoid cross-conduction (i.e. simultaneous conduction of both switches, which leads to current flowing from the battery directly to the ground via the switches, a phenomenon that degrades the efficiency and therefore must be avoided).

The reference signal V_{M} is the reference signal for the SMPS and it determines the output voltage V_{PA}. The output voltage V_{PA} is a function of the reference voltage V_{M}. This is illustrated in FIG. 3.

The reference voltage V_{M} is typically provided by the RFIC from a digital to analog converter DAC. The reference voltage may be controlled by the controller of the transmitter. Depending on the system and on the RF transmitter type, V_{M} may be only DC or amplitude modulated (DC+AC). In the first case, the power amplifier is supplied with a constant voltage V_{PA} with a value depending on the RF output power level. In the latter case, the power amplifier is supplied with an amplitude modulated V_{PA} that tracks the reference signal V_{M}.

FIG. 4 illustrates an example of a radio frequency transceiver to which embodiments of the invention may be applied. The transceiver comprises an antenna 104 and a transmitter 400 and a receiver 402. The receiver 402 is configured to receive transmission at a first radio frequency F_{RX}, and the transmitter 400 is configured to transmit at a second radio frequency F_{TX}. The duplex separation F_{DSEP} in the transceiver is thus |F_{Rx}−F_{TX}|.

The transceiver may comprise a duplex filter 404 connected to the antenna 104. The receiver comprises a power amplifier 405 configured to amplify a signal received with the antenna and filtered with the duplex filter 404.

The transmitter 400 comprises a power amplifier 100 configured to amplify a signal to be transmitted. From the power amplifier 100, the signal is taken to the antenna 104 via the duplex filter 404.

The power amplifier may be a fixed supply voltage amplifier. The supply voltage may be adjusted according to power level information by a controller. The transmitter may be an envelope tracking transmitter, an envelope elimination and restoration (EER) transmitter or a polar transmitter. In general, the structure of the transmitter and the control method of the supply voltage of the power amplifier do not limit the applicability of the embodiments of the invention.

The transceiver comprises a battery or a power source 106. The battery outputs a voltage V_{BAT} to a switching mode power supply SMPS 108. The SMPS converts the voltage V_{BAT} to another voltage V_{PA} which is used by the power amplifier 100 as a supply voltage.

The transceiver comprises a controller unit 406 which controls the units of the transceiver. The controller unit 406 provides the SMPS with a reference signal V_{M}. The transceiver further comprises a clock circuit 408 which provides the SMPS with a clock signal. In the SMPS, the clock signal determines the switching frequency of the SMPS.

The controller and the clock circuit may be implemented on a radio frequency integrated circuit (RFIC) of the transceiver.

The transceiver may be a base station transceiver or a mobile station transceiver. Embodiments of the invention are applicable in both cases. In the following non-limiting examples, it is assumed that the transceiver is a mobile station transceiver.

In communication systems, the duplex separation is generally a system parameter. Typically, a base station of a system transmits to the mobile stations information about the transmission frequencies and the duplex separation used in the cell of the base station. In the transceiver of FIG. 4, the controller unit keeps track of the radio parameters such as the frequencies and duplex separation used.

In an embodiment of the invention, an adaptive switching frequency of the switching mode power supply 108 is used in the transceiver. The switching frequency of the switching mode power supply 108 in the transmitter 400 is changed according to the frequency separation to the simultaneously active receiver in the transceiver. The switching frequency of the switching mode power supply may be varied on the basis of the duplex separation, i.e. the frequency separation of the transmission and reception radio frequencies F_{DSEP}=|F_{RX}-F_{TX}|.

Let us study some numerical examples. When the frequency separation F_{DSEP} is small, a high switching frequency may be used. As an example, the F_{S} might be approximately 50 MHz. This guarantees that the first harmonic of the F_{S} does not fall into its own receiver frequency channel but above it on a frequency plane. The situation is further improved by increased attenuation of the SMPS LC output filter at higher frequencies. However, using a high value for F_{S} means weakened SMPS efficiency.

When the frequency separation F_{DSEP} is large, a smaller switching frequency may be used. As an example, the F_{S} might be approximately 10 MHz or lower. In such a case the energy of the harmonic of the F_{S} that falls on top of its own received signal is low enough. Low F_{S} values mean good SMPS efficiency.

When the frequency separation F_{DSEP} is between small and large values, the target is to use low F_{S} values whenever possible to obtain good SMPS efficiency and low power consumption.

In an embodiment of the invention, the controller detects a change in the frequency separation F_{DSEP}. The frequency separation may change when a mobile station roams from a network of an operator to a network of another operator or if the network parameters of the current network of the mobile station are changed, for example. The change may also happen if a mobile phone is powered up in a new location where the network parameters are different compared to those of a previous location. It may also be possible that a mobile station may request a change in the network parameters.

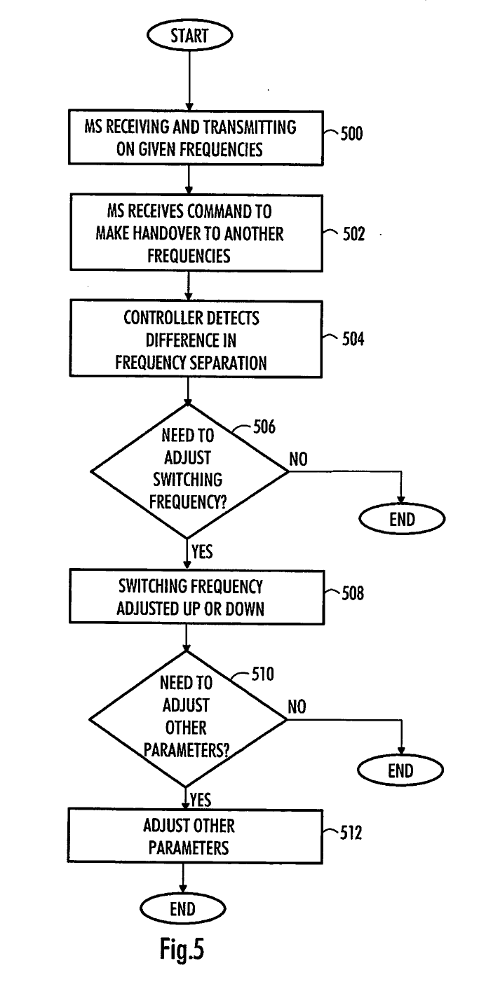

The flowchart of FIG. 5 illustrates an embodiment of the invention. In step 500, a mobile station is transmitting and receiving at given frequencies with a given frequency separation F_{DSEP1}. The switching frequency has a given value F_{S1}.

In step 502, the mobile station receives a command to perform a handover to other frequencies. The handover may be performed within a system or it may be a handover to another system.

Associated with the handover command, the controller of the mobile station may receive network information about the new frequencies. In step 504, the controller detects that the frequency separation F_{DSEP2} of the new frequencies is different compared to those of the previous F_{DSEP1}.

In step 506, the controller evaluates the need to adjust the switching frequency on the basis of the change in the frequency separation. The need to change the frequency separation may depend upon the amount and direction of the change and the present value F_{S1} of the switching frequency. For example, if the previous value F_{S1} of the switching frequency is low and the frequency separation increases, no need may exist to adjust the switching frequency. In such a case, the process ends. However, if the frequency separation decreases a need may exist to increase the switching frequency. In such a case, the switching frequency is adjusted in step 508.

In an embodiment, the switching frequency is adjusted by controlling the clock signal of the SMPS. Referring to FIG. 4, the controller 406 may control the clock circuit 408 which generates the clock signal CLK of the SMPS 108. If the SMPS has a free running pulse width modulator clock, the switching frequency may be adjusted by changing the slope of the PWM saw tooth generator according to a control signal from the controller.

In step 510, the controller evaluates the need to adjust other parameters of the transmitter of the mobile station. In such a case, the parameters are adjusted in step 512. As the interference generated by the SMPS switching frequency is only one factor in the transmitter noise in the antenna, the F_{S} change may be combined with some other parameter adjustments. For example, the bias of the power amplifier of the transmitter of the mobile station may be adjusted on the basis of the frequency separation. Referring to FIG. 4, the power amplifier 100 may be configured to adjust the bias according to information received from the controller 406.

In addition, the power stage of the SMPS may be reconfigured according to the required power level of the power amplifier. The power stage may be split into smaller parallel-connected ones. At a low power level, only part of the power stage is used, which reduces the switching losses, thus improving the efficiency.

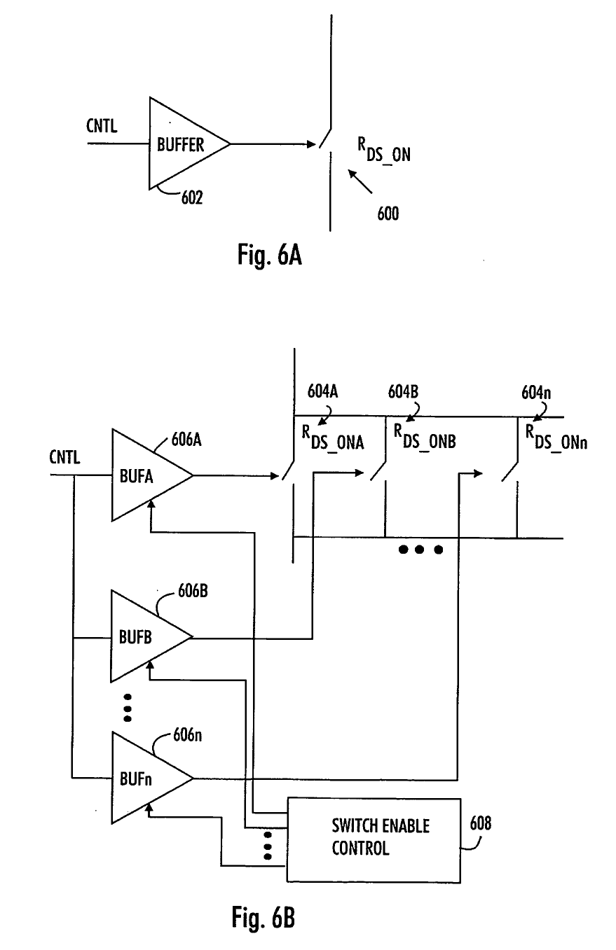

FIGS. 6A and 6B illustrate power switch splitting. Power switch splitting is a technique that can be applied to improve the efficiency of a switching converter at low power levels. The power switch, e.g. PMOS or NMOS device 206 or 208 in FIG. 2, is sized according to the current that must be handled. The higher the current, the lower the ON resistance (RDS_ON) of the switch must be and, in case of a MOS device, the wider the device (large W). However, a wider device will have a larger gate capacitance that must be driven, resulting into larger driving losses. Also the switching losses will be larger for a wider device. Therefore, the switch is not optimal at lower power levels when the current is less than the maximum current for which the switch has been designed.

FIG. 6A illustrates an example where splitting is not utilized. A power switch 600 with a buffer 602 and a specific RDS_ON are shown. The buffer 602 is needed to drive the power switch ON/OFF.

FIG. 6B illustrates the technique of power switch splitting. In this example, the power switch is split into two or more smaller switches 604A, 604B, 604N (each having a smaller W compared to switch 600) each with a resistance RDS_ON1, RDS_ONB, RDS_ONN and a buffer 606A, 606B, 606N. The sections may be symmetric or asymmetric (e.g. ½, ¼, ⅛ etc). The resulting total RDS_ON is the same as in the unsplit case, when all sections are in ON state. However, in this case it is possible to select which sections of the switch are active at a given moment. At lower power levels, when the current is lower, a higher ON resistance may be acceptable and some sections of the switch may be disabled. This will result in lower driving and switching losses. The conduction losses will go up due to the higher ON resistance of the partial switch. However, an overall improvement of the efficiency at low power levels may be obtained.

A control block 608 enables the sections of the switch according to information regarding the required power level or output current.

In short, in an embodiment of the invention, for frequency separation values below maximum ones, the controller increases the switching frequency of the SMPS. Additionally, at low power levels, the controller may also activate the power stage splitting to compensate, at least partially, for the efficiency degradation.

In addition, a mobile station may comprise more than one receiver (or transmitter). For example, a mobile station may be configured to communicate using in different systems with different transceivers. Thus, the mobile station may comprise a receiver being in connection to first system and a transmitter being in connection with another system. In addition, a mobile station may use a receiver for communication and another for measurement purposes. Thus, there may be a situation where a mobile station performs measurements in a radio frequency band and communicates with a transmitter in another frequency band. In addition, the duplex frequencies utilized by the receivers may be different. These parameters may be taken into account when determining the switching frequency.

In an embodiment of the invention, a general interference level of the reception frequency band may be taken into account when determining the switching frequency. The interference generated by the SMPS is only one factor in the receiver noise in the antenna. When the interference level is high, a switching frequency that is larger as compared to that of a situation when the interference level is low may be used. The interference level may be measured in the receiver using methods known in the art.

Embodiments of the invention may be realized in a transceiver comprising a controller configured to perform at least some of the steps described in connection with the flowchart of FIG. 5 and in connection with FIGS. 2A, 2B, 3, and 4. The embodiments may be implemented as a computer program comprising instructions for executing a computer process for controlling a switching mode power supply of the power amplifier of a transmitter in a radio frequency transceiver comprising a receiver for receiving transmission at a first radio frequency and a transmitter for transmitting at a second radio frequency, the process comprising: varying the switching frequency of the switching mode power supply on the basis of the frequency separation of the first and second radio frequency.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A radio frequency transceiver, comprising;
a receiver configured to receive transmission at a first radio frequency;
a transmitter configured to transmit at a second radio frequency;
a power amplifier in the transmitter with a switching mode power supply; and
a controller configured to vary switching frequency of the switching mode power supply on the basis of a frequency separation of the first and the second radio frequencies.

2. The transceiver of claim 1, wherein the controller is configured to increase a switching frequency of the switching mode power supply when the frequency separation of the first and the second radio frequencies decreases.

3. The transceiver of claim 1, wherein the controller is configured to decrease a switching frequency of the switching mode power supply when the frequency separation of the first and the second radio frequencies increases.

4. The transceiver of claim 1, wherein the controller is configured to adjust a bias of the power amplifier on the basis of the frequency separation of the first and the second radio frequencies.

5. The transceiver of claim 1, wherein the controller is configured to adjust a power stage of the power amplifier on the basis of a power level required by a signal to be transmitted.

6. The transceiver of claim 1, wherein the switching mode power supply comprises a pulse width modulator with a sawtooth generator, and the controller is configured to adjust a slope of the pulse width modulator sawtooth generator on the basis of the frequency separation of the first and the second radio frequencies.

7. The transceiver of claim 1, wherein the switching mode power supply comprises a clock signal, and that the controller is configured to adjust the frequency of the clock signal on the basis of the frequency separation of the first and the second radio frequencies.

8. The transceiver of claim 1, wherein the transceiver comprises a clock circuit providing the switching mode power supply with a clock signal, and that the controller is configured to control the frequency of the clock signal provided by the clock circuit.

9. The transceiver of claim 1, wherein the transceiver comprises more than one receiver, of which at least one receiver is configured to measure at a third frequency, the controller being configured to take the third frequency into account when varying the switching frequency.

10. The transceiver of claim 1, wherein the receiver is in connection to first system and the transmitter being in connection with another system.

11. A method for controlling a switching mode power supply, comprising:
receiving, in a receiver, a transmission at a first radio frequency; and
transmitting, with a transmitter, at a second radio frequency, wherein a switching frequency of the switching mode power supply is varied on the basis of a frequency separation of the first and the second radio frequencies.

12. The method of claim 11, further comprising increasing the switching frequency of the switching mode power supply when the frequency separation of the first and the second radio frequencies decreases.

13. The method of claim 11, further comprising decreasing the switching frequency of the switching mode power supply when the frequency separation of the first and the second radio frequencies increases.

14. The method of claim 11, further comprising adjusting a bias of the power amplifier on the basis of the frequency separation of the first and the second radio frequencies.

15. The method of claim 11, further comprising adjusting a power stage of the power amplifier on the basis of a power level required by a signal to be transmitted.

16. The method of claim 11, further comprising adjusting a slope of the pulse width modulator sawtooth generator on the basis of the frequency separation of the first and the second radio frequencies.

17. The method of claim 11, further comprising adjusting the frequency of the clock signal of the switching mode power supply on the basis of the frequency separation of the first and second radio frequency.

18. The method of claim 11, further comprising receiving a command to adjust the first and the second frequency and the frequency separation of the first and the second radio frequencies.

19. The method of claim 11, wherein the transmitting further comprises a transmitter having more than one receiver, of which at least one is used for measurement purposes at a third frequency and by taking the third frequency into account when varying the switching frequency.

20. A radio frequency transceiver, comprising:
receiving means for receiving transmission at a first radio frequency; and
transmitting means for transmitting at a second radio frequency;
power amplifying means, in the transmitting means, with a switching mode power supply; and
controlling means for varying switching frequency of the switching mode power supply on the basis of a frequency separation of the first and the second radio frequencies.

21. A radio frequency transmitter of a transceiver, comprising:
a receiver configured to receive transmissions at a first radio frequency, the transmitter being configured to transmit at a second radio frequency;
a power amplifier with a switching mode power supply; and
a controller configured to vary switching frequency of the switching mode power supply on the basis of a frequency separation of the first and the second radio frequencies.

22. A switching mode power supply in a radio frequency transmitter of a transceiver, comprising:
a receiver configured to receive a transmission at a first radio frequency; and
a transmitter configured to transmit at a second radio frequency; wherein a switching frequency of the switching mode power supply is adjustable on the basis of a frequency separation of the first and the second radio frequencies.

23. A computer program embodied on a computer readable medium, that when executed by a processor, is configured to control a switching mode power supply of a power amplifier of a transmitter in a radio frequency transceiver comprising a receiver for receiving transmission at a first radio frequency and a transmitter for transmitting at a second radio frequency, the process comprising varying switching frequency of the switching mode power supply on the basis of a frequency separation of the first and the second radio frequencies.

24. The computer program distribution medium of claim 23, the distribution medium including at least one of the following media: a computer readable medium, a program storage medium, a record medium, a computer readable memory, a computer readable software distribution package, a computer readable signal, a computer readable telecommunications signal, and a computer readable compressed software package.
